(19) United States
(12) Patent Application Publication
(10) Pub. No.: US 2026/0125185 A1
(43) Pub. Date: May 7, 2026

(54) Container Section Device (Tri Pots)

(71) Applicants: George Daniel Fox, San Jacinto, CA (US); Kurt Alan Sawatzky, Hemet, CA (US)

(72) Inventors: George Daniel Fox, San Jacinto, CA (US); Kurt Alan Sawatzky, Hemet, CA (US)

(21) Appl. No.: 19/330,188

(22) Filed: Sep. 16, 2025

Related U.S. Application Data
(60) Provisional application No. 63/697,493, filed on Sep. 21, 2024.

(51) Int. Cl. B65D 25/08; B44D 3/12; B65D 1/16; B65D 21/02; B65D 25/10; B65D 25/22; B65D 25/28

(52) U.S. Cl. CPC B65D 25/08; B44D 3/128; B65D 1/16; B65D 21/0233; B65D 25/108; B65D 25/22; B65D 25/282; B65D 2525/285

(57) ABSTRACT

A modular insert system that divides a container—e.g., a standard bucket—into multiple isolated compartments using wedge-shaped sections. Each section fits snugly, includes an over-rim support to hold position, and can be individually removed for filling, pouring, or cleaning. Optional accessories (brush holders, lids, slide-on handles, ladder-hook carry handle) and alternative bucket geometries are contemplated. Applications include painting, construction, food service, janitorial, floristry, outdoor, mechanical, and household uses.

### CROSS-REFERENCE TO RELATED APPLICATIONS

This application claims the benefit of U.S. Provisional Application No. 63/697,493, filed Sep. 21, 2024, under U.S.C. §119(e).

Title: Container Section Device (Tri Pots)

Inventors: George Daniel Fox; Kurt Alan Sawatzky

### FIELD OF THE INVENTION

This disclosure relates to container partition systems and, more particularly, to removable section inserts that divide a bucket into multiple separately usable compartments, with structures that aid pouring, scooping, carrying, and tool retention.

### BACKGROUND

Workers often need multiple products in one work area while keeping them separate (e.g., painters carrying multiple colors up ladders). Conventional trays and caddies either occupy only shallow portions of a bucket, cannot be separated for individual use, or cannot manage liquids independently. There is a need for a system that uses substantially the full bucket depth, allows independent handling of each compartment, and remains stable in the bucket during use.

### SUMMARY

The system comprises multiple wedge-shaped sections that nest together in a bucket to form isolated compartments. Each section presents (i) a curved outer wall that conforms to the bucket interior; (ii) flat interior walls that meet adjacent sections; and (iii) an upper over-rim support portion that resists inward movement and rotation. Sections can be individually removed for filling, emptying, pouring, or cleaning while remaining sections stay in place. Accessories include central brush holders, section lids, and handles, including a slide-on handle that doubles as a tool support and a ladder-hook carry handle.

### BRIEF DESCRIPTION OF THE DRAWINGS

FIG. 100 is an isometric of a single section from an upper outer view.

FIG. 110 is an isometric of a single section from a lower outer view.

FIG. 120 is an isometric of a single section from an inner lower view toward the center seam.

FIG. 130 is an isometric of a single section from an inner upper view toward the center seam.

FIG. 140 is an isometric of the semi-assembled device with one section separated.

FIG. 150 is an isometric of the fully assembled device within a bucket.

FIG. 160 is a slide-on handle; FIG. 160A-160E show attachment modes and features.

FIG. 170 shows top and bottom views of a center-retention brush holder; FIG. 170A shows central placement.

FIG. 180 shows top and bottom views of a treble brush holder; FIG. 180A shows central placement.

FIG. 190 shows lids for individual sections; FIG. 190A shows an upper side and insertion.

FIG. 200 shows a ladder-hook carry handle; FIG. 200A shows placement on a bucket over a ladder rung.

FIG. 210 is an exploded assembly showing alternative accessory storage configurations.

FIG. 220 illustrates a five-gallon embodiment with full-depth sections.

### DETAILED DESCRIPTION OF THE DRAWINGS

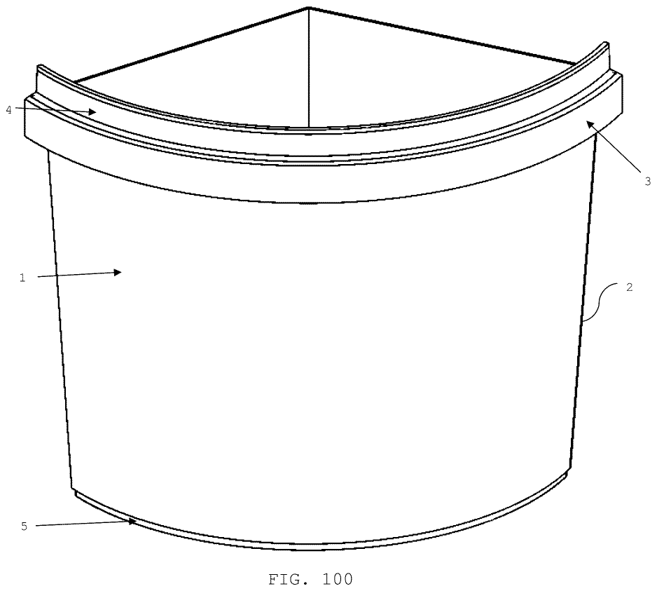

FIG. 100 is an isometric view of a single section from the curved outer wall at an upper angle, showing: curved outer wall (1); interior flat wall (2) (posterior side); over-rim portion (3); top rim (4); and bottom edge. Leader 2 identifies the interior flat wall/posterior side.

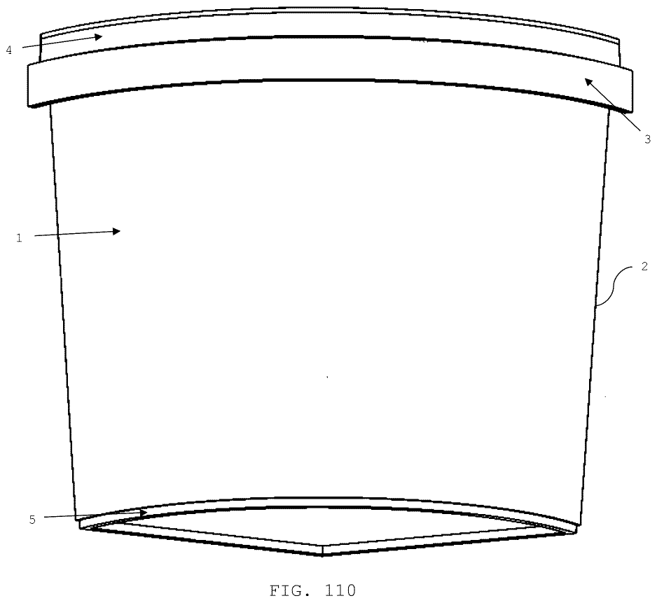

FIG. 110 is an isometric view of a single section from the curved outer wall at a lower angle. Leader 2 identifies the interior flat wall/posterior side.

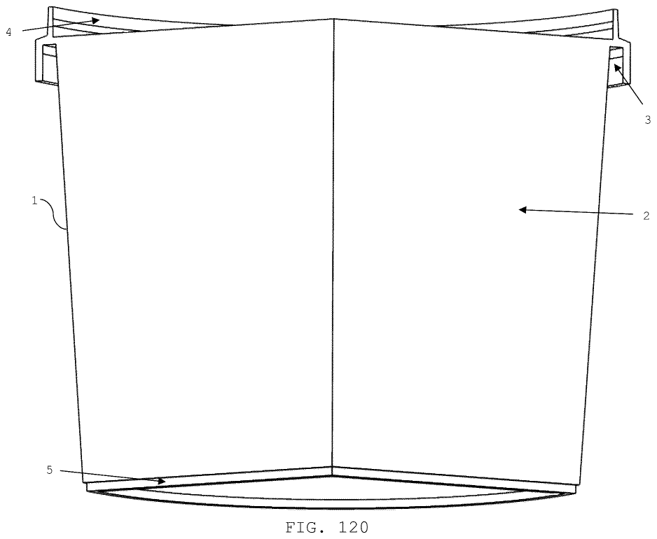

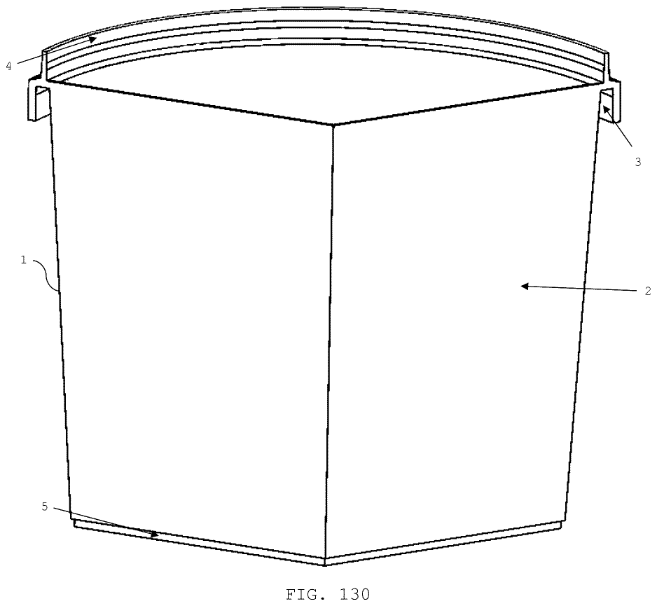

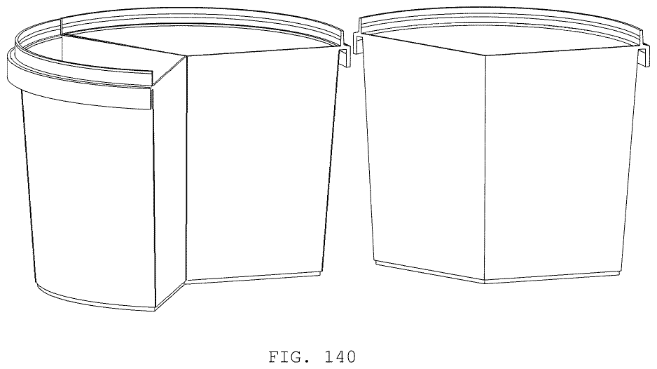

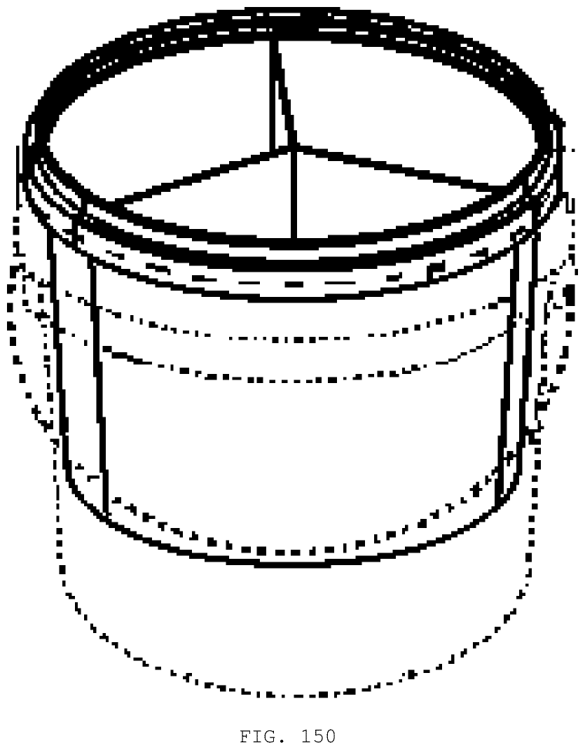

FIG. 120 is an isometric view of a single section from the inside/lower angle, toward the center where sections meet. Leader 1 identifies the curved outer wall/posterior side.

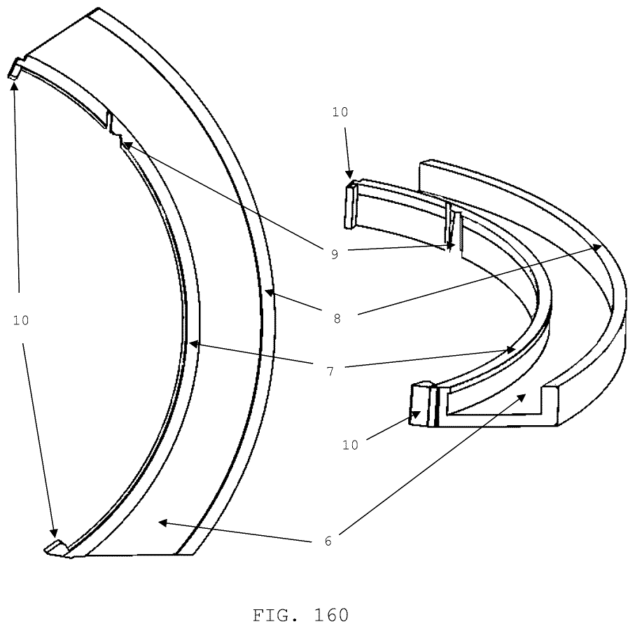

FIG. 130 is an isometric view of a single section from the inside/upper angle, toward the center where sections meet. Leader 1 identifies the curved outer wall/posterior side.

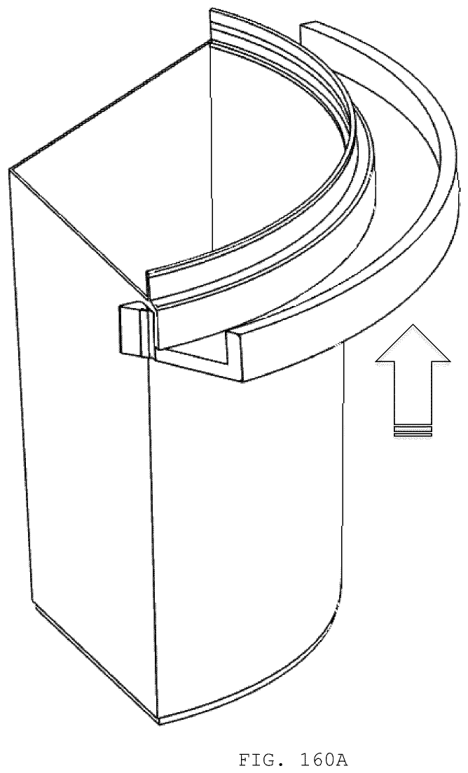

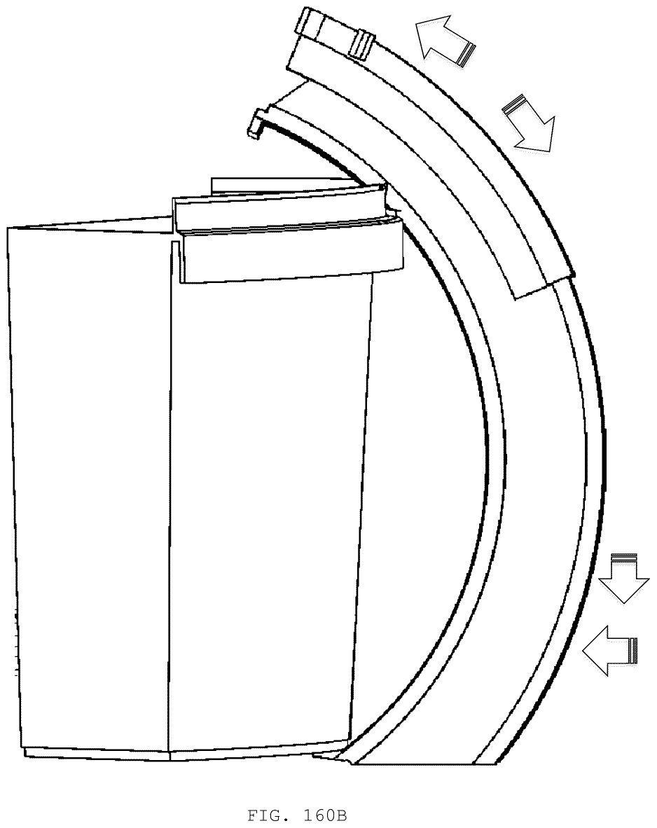

FIG. 140 is an isometric view of the semi-assembled device with one section separated to illustrate insertion.

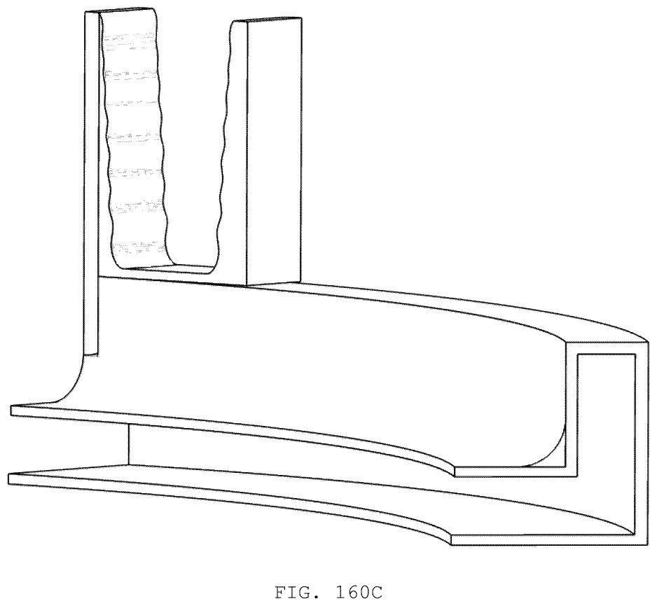

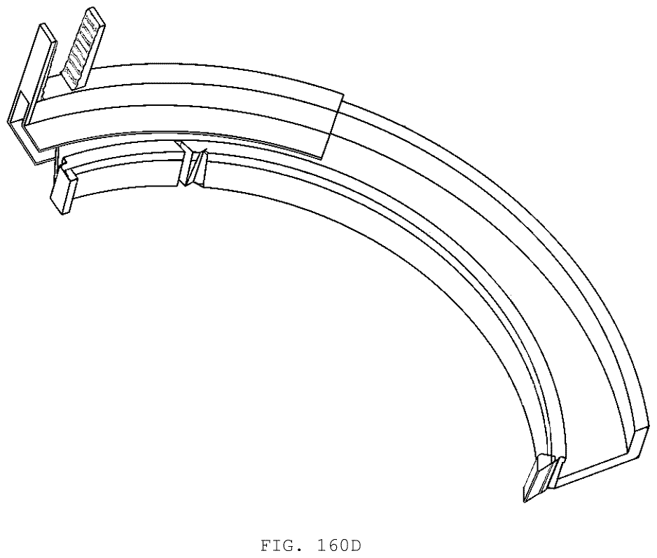

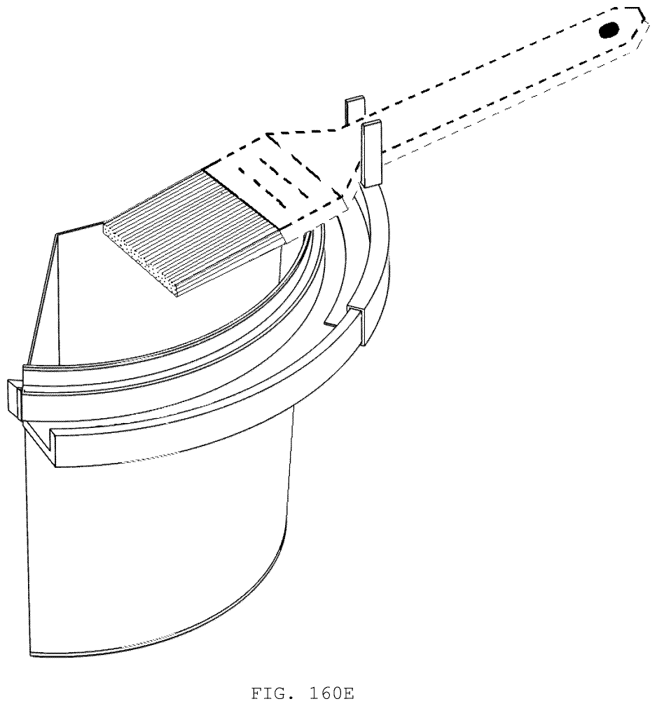

FIG. 160 is a slide-on handle for a section, showing a curved body (6), inner lip (7), outer lip (8), notch (9), side ears (10). Sub-figures 160A-E illustrate vertical and horizontal attachment modes and compatibility with a brush/tool holder.

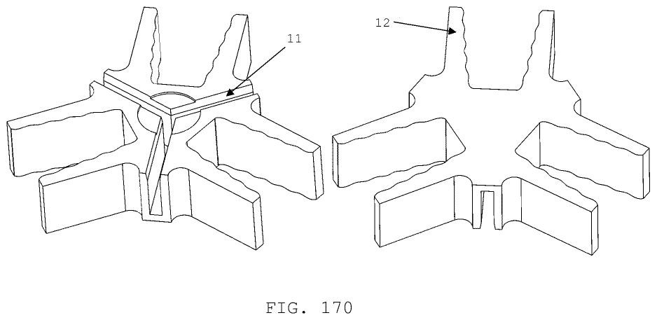

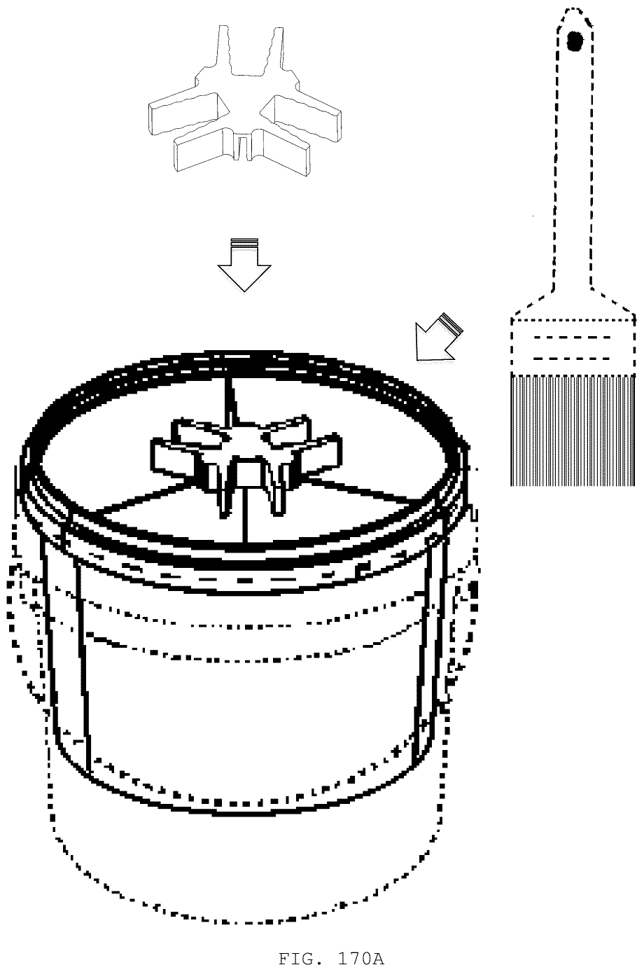

FIG. 170 is top and bottom views of a Center Retention Clip brush holder seated at the convergence of the three sections, having a star-shaped center anchor (11) and integrated clip arms (12) that friction-hold two brush handles upright with bristles oriented into the corners of their respective sections. FIG. 170A shows central placement between the three sections.

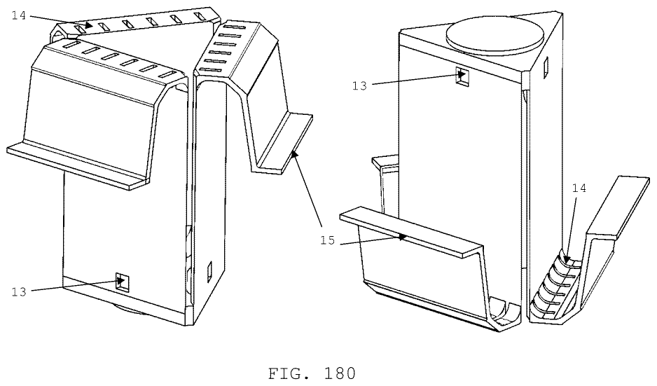

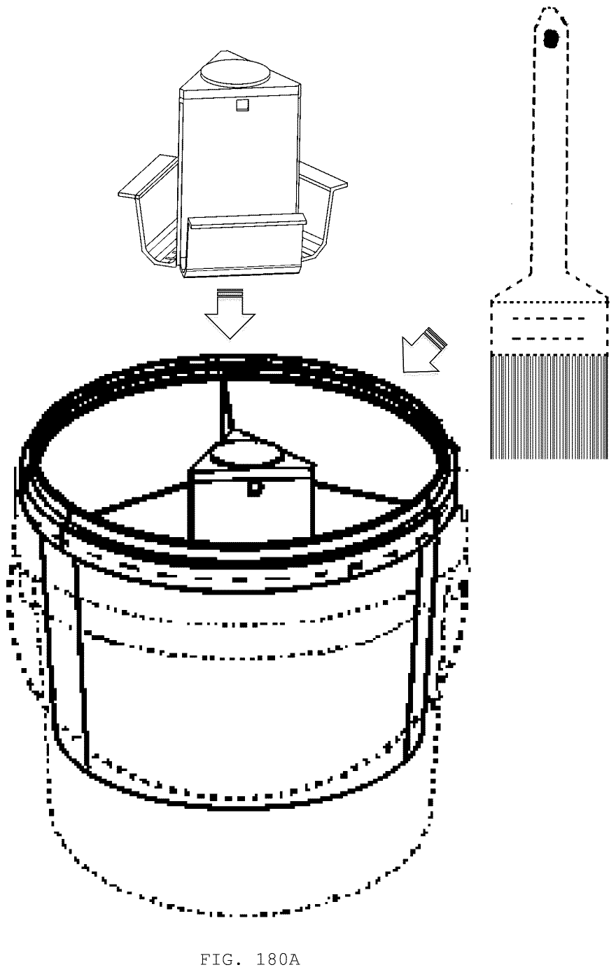

FIG. 180 is top and bottom views of a Treble Brush Holder including a magnet seat (13) to retain metal ferrules, drainage slots and cradle (14) that position bristles within a selected section, and a wiping ledge (15); FIG. 180A shows central placement between the three sections.

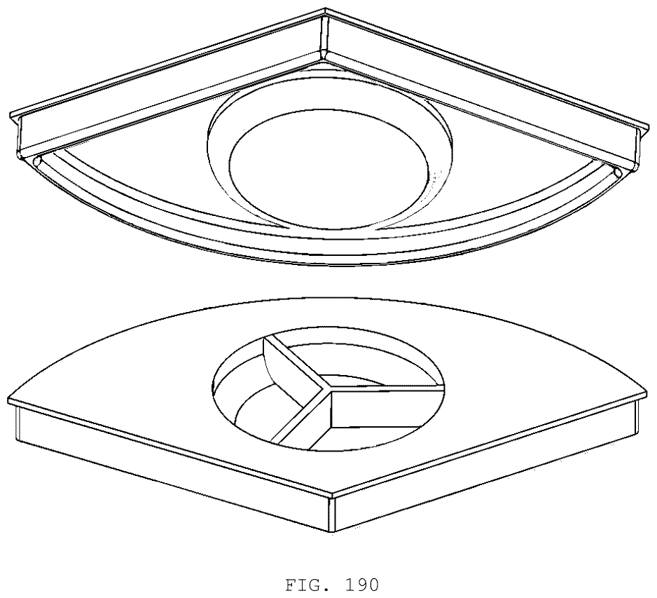

FIG. 190 shows lids for individual sections; sub-figure 190A shows upper side and insertion.

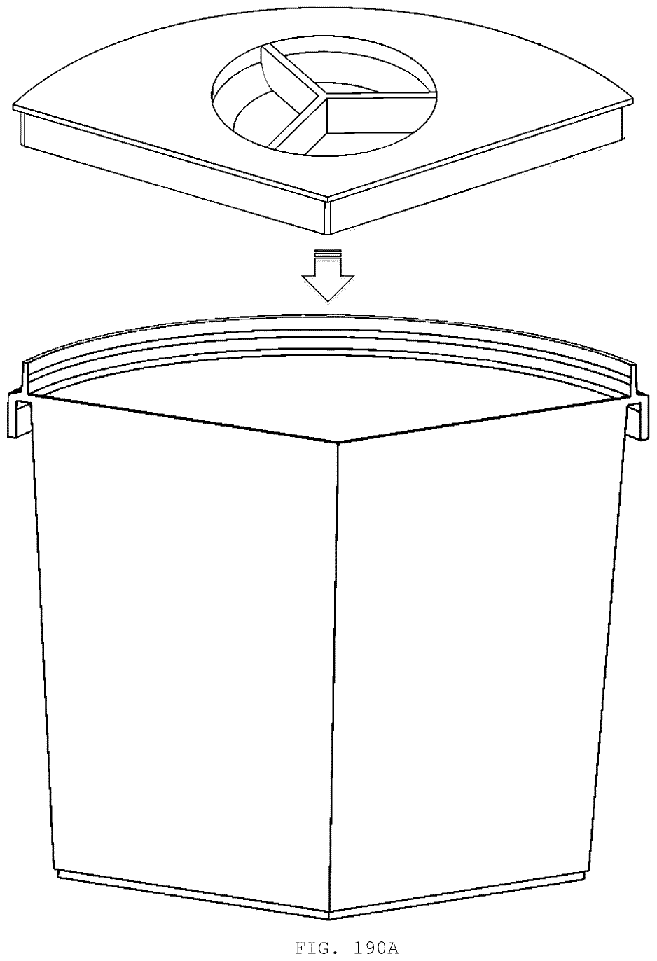

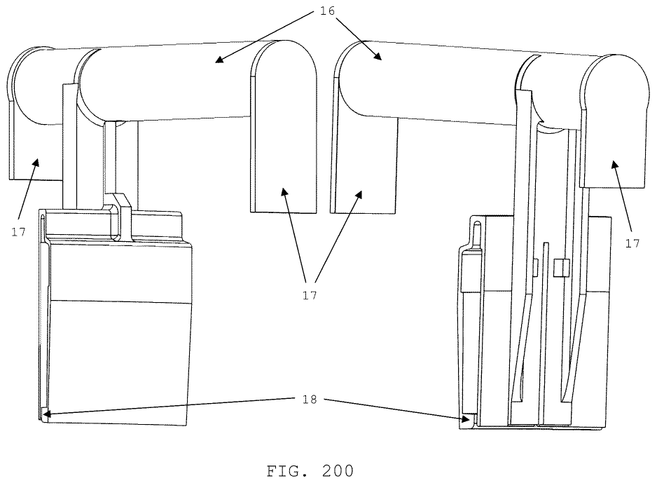

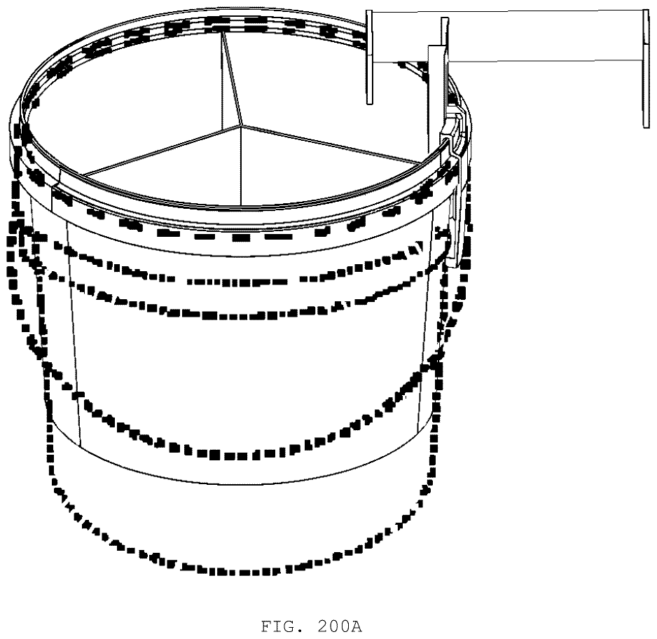

FIG. 200 shows a ladder-hook carry handle with offset grip (16), downward ladder hook portions (17), and undercut groove (18) that engages the bucket rim without lifting a section. FIG. 200A shows placement over side of container section and bucket wall. The longer outboard handle portion with its downward hook (17) allows for positioning on a wide step rung of a ladder while the bucket is also supported by the step below. The shorter inboard handle portion and downward hook allow for positioning on a narrower rung such as on the back side of an A-frame ladder or its spreader brace for a better balance point and bucket angle.

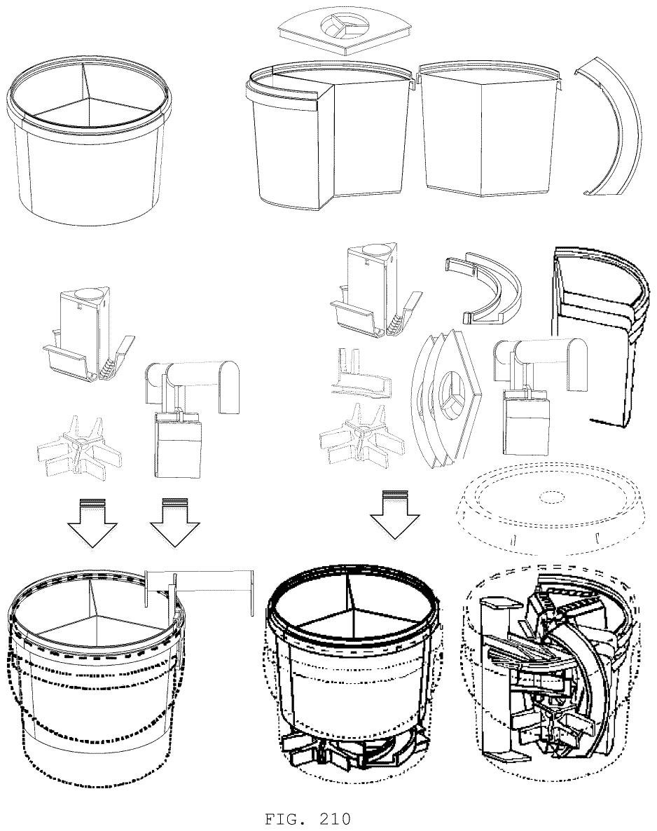

FIG. 210 is an exploded assembly showing alternative accessory storage configurations: (i) accessories beneath the inserted sections; or (ii) accessories beside the sections when the sections are nested. Only one configuration is used at a time.

### REFERENCE NUMERALS KEY

(1) Curved outer wall of section; (2) Flat interior/mating wall; (3) Over-rim support portion; (4) Top rim; (5) Bottom edge; (6) Curved handle body; (7) Inner lip; (8) Outer lip; (9) Notch; (10) Ear; (11) Star-shaped center anchor; (12) Integrated clip arms; (13) Magnet seat; (14) Cradle and drainage slots; (15) Wiping ledge; (16) Offset handle grip; (17) Ladder hook portion; (18) Undercut groove.

### DETAILED DESCRIPTION

### A. Core Sections

See FIG. 100-130, 140-150.

In a preferred tri-compartment embodiment, three identical wedge-shaped sections occupy the bucket interior. Each section's curved wall (1) conforms to the bucket wall; the flat walls (2) meet adjacent sections along straight seams; and an over-rim portion (3) engages the bucket rim to resist inward movement and rotation while providing a graspable top rim (4). The bottom edge (5) defines section depth. Sections are removable individually without disturbing remaining sections.

### B. Handle for Section-Level Carry and Tool Support (FIGS. 160, 160A-160E)

See FIG. 160 and FIG. 160A-160E.

A slide-on handle comprises a curved body (6) with inner lip (7) and outer lip (8). A notch (9) engages the section top rim (4). Side ears (10) wrap around flat walls (2) as the handle slides upward, securing by friction. In vertical mode, the handle clips to the top rim and bottom edge for single-section carry; in a horizontal mode, the handle spans the section mouth and can accept a brush/tool holder sliding along outer lip (8).

### C. Central Brush Holders (FIGS. 170, 170A, 180, 180A)

See FIGS. 170, 170A, 180, and 180A.

A Center Retention Clip is located at the center between the three sections using a star-shaped anchor (11) and friction clip arms (12) to hold brushes upright with bristles oriented toward the corners of the respective sections. A Treble Brush Holder features a magnet seat (13) to retain metal ferrules, a slotted cradle (14) for draining excess paint while positioning bristles within a selected section, and a wiping ledge (15). Both position bristles into the corresponding section to minimize contamination. Only one central brush holder is installed at a time, either the Center Retention Clip (FIG. 170/170A) or the Treble Brush Holder (FIG. 180/180A).

### D. Section Lids (FIGS. 190, 190A)

See FIGS. 190 and 190A.

Low-profile lids rest flush with the section top edges, avoiding interference with insertion/removal. The lids may be formed from a relatively flexible polymer (e.g., LDPE or TPE) that conforms to the section rim to provide splash resistance and reduce evaporation/paint skinning; the lids are not intended to be airtight storage closures. The profile allows storage beneath or beside the sections and, in bucket-wide use, compatibility with a standard bucket lid applied over the sections for stacking.

### E. Ladder-Hook Carry Handle (FIGS. 200, 200A)

See FIGS. 200 and 200A.

A removable handle with an offset grip (16) clears center-mounted brush holders. Downward hook portions (17) allow hanging on a ladder rung. An undercut groove (18) engages the bucket rim, transferring load to the bucket rather than lifting a section.

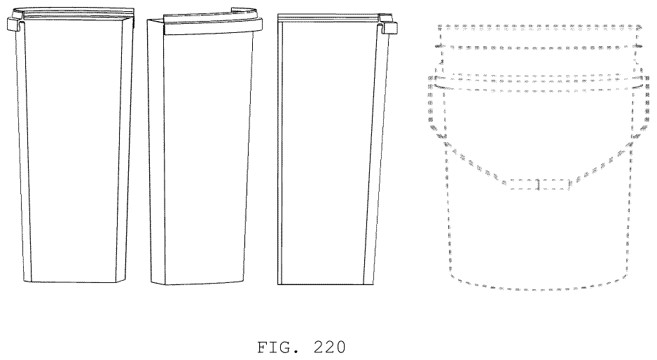

### F. Alternative Bucket Sizes and Depths (FIGS. 210 and 220; Two-Gallon/Five-Gallon Variants)

See FIG. 210 (Two-Gallon) and 220 (Five-Gallon).

In a five-gallon configuration, sections extend to the bucket bottom to maximize capacity and shift weight to the base. In a two-gallon configuration, sections can be partial-depth to enable stowing lids and accessories below; sections are nestable for compact storage, and a standard round bucket lid may be applied over inserted sections during use.

### G. Manufacturing and Materials

Sections may be injection-molded from HDPE or other thermoplastics (e.g., LDPE, PVC, ABS), thermoformed, blow-molded, or produced as disposable liners. Accessories may be molded plastics, elastomers, or metals as appropriate for load and environment. Food-grade variants are contemplated.

### H. Use Cases

Painting (multi-color touch-ups on ladders), construction (pre-measured mixes and water), food service (rapid cooling via increased surface area; perforated outer buckets for airflow), floristry (different liquid levels or dry storage), outdoors (camping waste/food separation; fishing tackle and catches), mechanical/maintenance (parts cleaning/organization), household/janitorial sorting.

### ADVANTAGES

Substantially full bucket-depth utilization.
Independent removal/refill/cleaning of any section.
Stable in-bucket positioning with anti-rotation over-rim support.
Centralized tool retention options; optional lids; optional handles.
Nesting for storage and transport; compatibility with standard bucket lids.

What is claimed is:

1. A modular insert system for dividing the interior of a container, comprising:
a. a plurality of wedge-shaped container sections, each section having an interior-facing flat wall and an exterior-facing curved wall configured to conform to an interior wall of a bucket.
b. a support portion at an upper edge of each section that engages a rim region of the bucket to support the section in place and resist inward movement; and
c. wherein the sections, when inserted together, collectively divide the interior volume of the bucket into multiple isolated compartments.

2. The system of claim 1, wherein three sections completely fill a cylindrical bucket to form a tri-compartment configuration.

3. The system of claim 1, wherein the sections extend to the bottom of the bucket to increase capacity and transfer load to the bottom.

4. The system of claim 1, wherein any section is removable independently for filling, emptying, pouring, or cleaning while remaining sections stay in place.

5. The system of claim 1, further comprises a brush holder positioned in a center region between sections to hold at least one brush vertically.

6. The system of claim 5, wherein the brush holder includes a magnetic element to retain a metal brush ferrule.

7. The system of claim 5, wherein the brush holder includes a slotted cradle and a wiping ledge proximate a section edge.

8. The system of claim 1, further comprising lids configured to cover individual sections with a low profile that remains flush with section top edges.

9. The system of claim 1, wherein the sections are nestable for compact storage and transport.

10. The system of claim 1, wherein the support portion comprises an over-rim lip that overlaps a rim of the bucket and includes an anti-rotation feature selected from a snap-bead, undercut, notch, or friction surface.

11. The system of claim 1, further comprising a slide-on handle attachable to an individual section, the handle including a curved body with an inner lip, an outer lip, and side ears that engage the section by friction in vertical or horizontal orientations.

12. The system of claim 11, further comprising a tool holder configured to slide along the outer lip of the handle.

13. The system of claim 1, further comprising a ladder-hook carry handle with an offset grip and a bucket-rim-engaging undercut, the handle configured to hang from a ladder rung.

14. The system of claim 1, wherein the bucket is selected from standard commercial round buckets and custom buckets having polygonal or oval cross-sections.

15. The system of claim 1, wherein the sections are partial-depth relative to a two-gallon bucket to provide a storage space below the sections for lids or accessories while a standard one-piece bucket lid is applied above.

16. The system of claim 1, wherein a perforated outer bucket enhances air flow around inserted sections to accelerate cooling of food liquids.

17. The system of claim 1, wherein the sections are produced as disposable liners compatible with reusable sections.

18. The system of claim 1, wherein at least one section includes a corner geometry transitioning from a filleted bottom corner to a sharper upper corner to form a pour spout.

19. The system of claim 1, wherein sections of differing sizes are combinable to form the compartments, including half-circle and fractional sectors sized to nest within one another.

20. The system of claim 8, wherein each lid is formed from a flexible polymer configured to conform to a section's top edge to impede evaporation and reduce paint skinning without forming an airtight seal.
